(19) United States
(12) Patent Application Publication
(10) Pub. No.: US 2009/0287854 A1
(43) Pub. Date: Nov. 19, 2009

(54) DETECTING DEVICE

(75) Inventor: Chung-Ta Chin, Taipei (TW)

Correspondence Address: WPAT, PC, 7225 BEVERLY ST., ANNANDALE, VA, 22003, US

(73) Assignee: ASUSTeK COMPUTER INC., Taipei (TW)

(21) Appl. No.: 12/429,610

(22) Filed: Apr. 24, 2009

(30) Foreign Application Priority Data
May 15, 2008 (TW) 097117889

(51) Int. Cl. G06F 3/00

(52) U.S. Cl. 710/16

(57) ABSTRACT

A detecting device is mounted on a motherboard for detecting a connecting status of an external device. The detecting device includes a control chip, a pull-up element, a jack and a detecting chip. The jack has one or more first-type electrical wires, one or more second-type electrical wires and a third-type electrical wire. The first-type electrical wires are connected to the control chip for receiving and transmitting data. The second-type electrical wires are connected to a first voltage. The third-type electrical wire is connected to a second voltage through the pull-up element. The detecting chip has an I/O pin connected to the third-type electrical wire of the jack. When the external device is not connected to the jack, the third-type electrical wire is maintained at the second voltage. When the external device is connected to the jack, third-type electrical wire is not maintained at the second voltage.

### FIELD OF THE INVENTION

The present invention relates to a detecting device, and more particularly to a detecting device for detecting the connecting status between a SATA jack and an external device.

### BACKGROUND OF THE INVENTION

Conventionally, an ATA (Advanced Technology Attachment) interface is used for data transmission between a storage device (e.g. a hard disk or an optic disk drives) and a motherboard. Since the ATA interface transfers data in a parallel mode, the ATA interface is also referred as a PATA interface. Recently, a SATA (Serial Advanced Technology Attachment) interface has gradually replaced the PATA interface to transfer data between the motherboard and the storage device.

FIG. 1A is a schematic perspective view illustrating a conventional SATA connector. As shown in FIG. 1A, the SATA connector comprises a SATA plug 120 and a SATA jack 100. The SATA jack 100 has two insertion slots. The SATA plug 120 can be inserted into either of the two insertion slots of the SATA jack 100.

In addition, there are seven electrical wires in the insertion slot of the SATA jack 100. The first, fourth and seventh electrical wires are relatively longer and defined as ground wires. The second and third electrical wires, which are arranged between the first and fourth electrical wires, are defined as transmitting wires (Tx). The fifth and sixth electrical wires, which are arranged between the fourth and seventh electrical wires, are defined as receiving wires (Rx). Similarly, the SATA plug 120 has seven electrical wires mating with the seven electrical wires of the SATA jack 100. When the SATA plug 120 is inserted into an insertion slot of the SATA jack 100, the seven pairs of electrical wires are contacted and electrically connected with each other. Furthermore, the SATA plug 120 has two electromagnetic shielding metals 124 and 126. The two transmitting wires (Tx) are enclosed by the electromagnetic shielding metal 124. The two receiving wires (Rx) are enclosed by the electromagnetic shielding metal 126. These two electromagnetic shielding metals 124 and 126 are connected to the first, fourth and seventh electrical wires (i.e. the ground wires). By means of the two electromagnetic shielding metals 124 and 126, the adverse influence resulting from electro-magnetic interference (EMI) is avoided and thus the speed of transmitting and receiving data is enhanced.

FIG. 1B is a schematic view illustrating the connection between a SATA jack and a control chip that are mounted on a motherboard according to the prior art. FIG. 1C is a schematic circuit diagram illustrating the connection between a control chip, a SATA connector and a storage device according to the prior art. Please refer to FIGS. 1B and 1C. The control chip 130 is for example a south bridge chip. The control chip 130 has two transmitting pins (Tx) and two receiving pins (Rx). The two transmitting pins (Tx) are connected to the second and third electrical wires of the SATA jack 100. The two receiving pins (Rx) are connected to the fifth and sixth electrical wires of the SATA jack 100. The first, fourth and seventh electrical wires of the SATA jack 100 are directly connected to a ground layer of the motherboard. After a supply voltage (Vcc) is transmitted to the storage device 140 through a power cord and the SATA plug 120 of the storage device 140 is inserted into an insertion slot of the SATA jack 100, the storage device 140 is electrically connected to the control chip 130.

As previously described, the current SATA interface standard defines four signal wires (i.e. two transmitting wires (Tx) and two receiving wires (Rx)) and three ground wires. Except for these seven electrical wires, no additional electrical wire is available. Since no detecting pin is defined by the SATA interface standard, the computer system fails to detect whether the storage device 140 has been installed in the computer system even if the SATA plug 120 of the storage device 140 is inserted into an insertion slot of the SATA jack 100 mounted on the motherboard 150.

Generally, the computer system may realize whether the storage device 140 is connected to computer system during the BIOS (basic input output system) is running. When the computer system is booted and the BIOS is running, the BIOS will initialize the control chip 130. After the control chip 130 is successfully initiated, the control chip 130 will issue an inquire command through the SATA jack 100. If the storage device 140 is connected to the SATA jack 100, a response signal is sent back to the control chip 130 to indicate that the storage device 140 is connected to computer system. Whereas, if no response signal is sent back to the control chip 130 after a predetermined time period, it is meant that no storage device is inserted to the SATA jack 100.

The process of detecting whether any storage device is inserted to the SATA jack is time-consuming. In addition, this detecting process is only implemented during the computer system is booted. After the booting procedure of the computer system has been finished, the computer system fails to realize whether the storage device 140 is connected to computer system even if the storage device 140 is inserted to the SATA jack 100. In other words, only when the computer system is re-started, the computer system is able to detect whether the storage device 140 is connected to computer system.

### SUMMARY OF THE INVENTION

The present invention relates to a detecting device for detecting the connecting status between a SATA jack and an external device.

In accordance with an aspect of the present invention, there is provided a detecting device of a motherboard for detecting a connecting status of an external device. The detecting device includes a control chip, a pull-up element, a jack and a detecting chip. The jack includes one or more first-type electrical wires, one or more second-type electrical wires and a third-type electrical wire. The first-type electrical wires are connected to the control chip for receiving and transmitting data. The second-type electrical wires are connected to a first voltage. The third-type electrical wire is connected to a second voltage through the pull-up element. The detecting chip has an I/O pin connected to the third-type electrical wire of the jack. When the external device is not connected to the jack, the third-type electrical wire is maintained at the second voltage. When the external device is connected to the jack, third-type electrical wire is not maintained at the second voltage.

In accordance with another aspect of the present invention, there is provided a detecting device of a motherboard for detecting a connecting status of an external device. The detecting device includes a control chip, a pull-up element, a jack, an electronic switch and a detecting chip. The electronic switch is arranged between the third-type electrical wire and the first voltage. The detecting chip includes an I/O pin connected to the third-type electrical wire of the jack. When the external device is not connected to the jack, the third-type electrical wire is disconnected from the first voltage by the electronic switch such that the third-type electrical wire is maintained at the second voltage. When the external device is connected to the jack, the third-type electrical wire is connected to the first voltage by the electronic switch such that the third-type electrical wire is maintained at the first voltage.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic perspective view illustrating a conventional SATA connector;

FIG. 1B is a schematic view illustrating the connection between a SATA jack and a control chip that are mounted on a motherboard according to the prior art;

FIG. 1C is a schematic circuit diagram illustrating the connection between a control chip, a SATA connector and a storage device according to the prior art;

FIG. 2 is a schematic view illustrating the connection between an external device and a detecting device according to a first preferred embodiment of the present invention; and

FIG. 3 is a schematic view illustrating the connection between an external device and a detecting device according to a second preferred embodiment of the present invention.

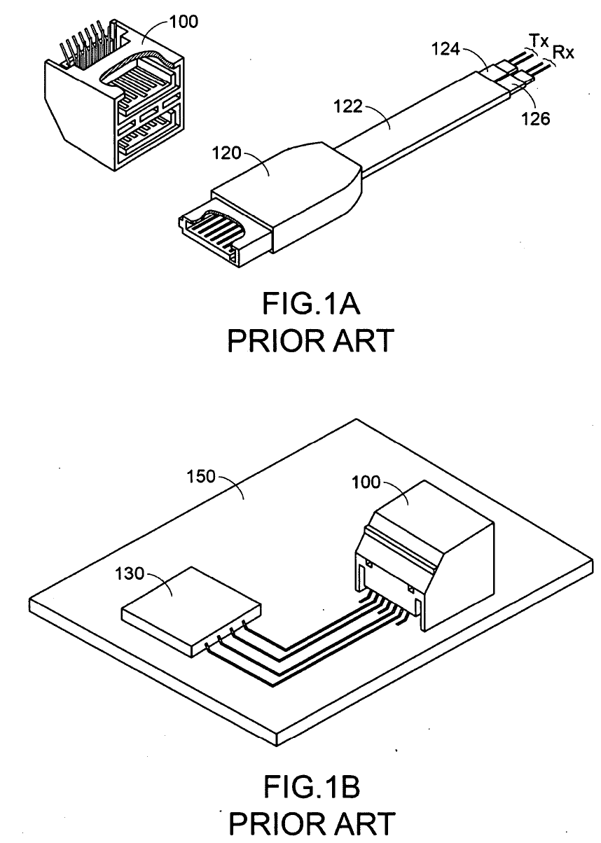

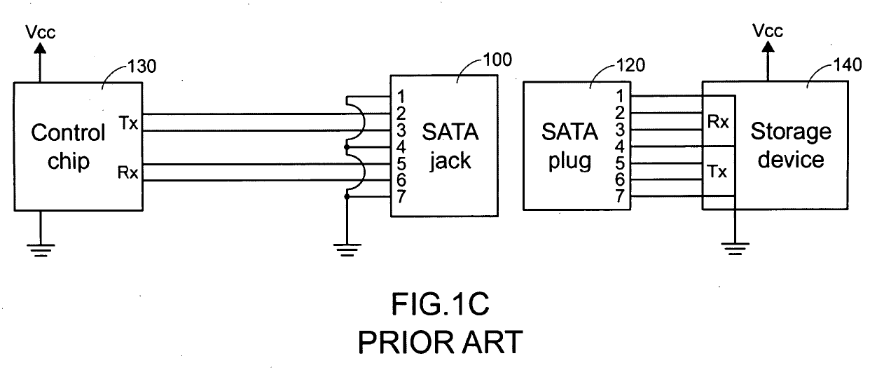

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

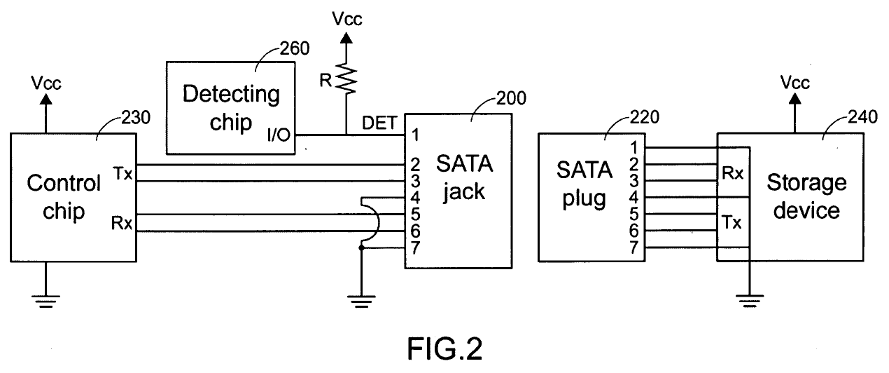

FIG. 2 is a schematic view illustrating the connection between an external device and a detecting device according to a first preferred embodiment of the present invention. As shown in FIG. 2, the detecting device of the present invention principally comprises a control chip 230, a pull-up element (e.g. a pull up resistor R), a SATA jack 200 and a detecting chip 260. An example of the control chip 230 is a south bridge chip. The control chip 230 has two transmitting pins (Tx) and two receiving pins (Rx). In accordance to a key feature of the present invention, one of the three ground wires defined by the SATA interface standard (e.g. the first, fourth and seventh electrical wires) is used as a detecting pin DET. For example, as shown in FIG. 2, the first electrical wire is used as the detecting pin DET. The first electrical wire is connected to the supply voltage (Vcc) through the pull up resistor R.

Except for the first electrical wire serving as the detecting pin, the other electrical wires of the SATA jack 200 are kept unchanged. In other words, the two transmitting pins (Tx) of the control chip 230 are connected to the second and third electrical wires of the SATA jack 200; and the two transmitting pins (Tx) are connected to the fifth and sixth electrical wires of the SATA jack 200. In addition, the fourth and seventh electrical wires of the SATA jack 200 are directly connected to a ground layer of the motherboard.

Furthermore, an I/O pin of the detecting chip 260 is connected to the detecting pin DET of the SATA jack 200. According to the signal transmitted from the detecting pin DET, the detecting chip 260 can realize whether the SATA plug 220 of an external device 240 is inserted into the SATA jack 200. In this embodiment of the external device 240 is a storage device. An example of the detecting chip 260 includes but is not limited to a super I/O device, a general purpose I/O (GPIO) device or a south bridge chip.

The operations of the detecting chip 260 will be illustrated as follows. In a case that the external device 240 is detached from the SATA jack 200, the voltage level at the detecting pin DET of the SATA jack 200 is pulled up to a high-level state. Whereas, if the SATA plug 220 of the external device 240 is inserted into the SATA jack 200, the voltage level at the detecting pin DET of the SATA jack 200 is pulled down to a low-level state because the first electrical wire (e.g. a ground wire) of the SATA plug 220 is connected to the ground voltage. At the time when the detecting chip 260 detects the low-level state of the detecting pin DET, the detecting chip 260 may realize that the SATA plug 220 of the external device 240 is inserted into the SATA jack 200. In addition, the current generated by the supply voltage (Vcc) will flow to the ground layer through the pull up resistor R and the external device 240.

Since the first electrical wire of the SATA plug 220 is connected to the ground voltage when the SATA plug 220 of the external device 240 is inserted into the SATA jack 200, the SATA plug 220 and the SATA jack 200 still conform to the definition of SATA interfaces. Although the SATA jack 200 does not conform to the definition of a SATA interface when no external device is inserted into the SATA jack 200, no adverse influence occurs.

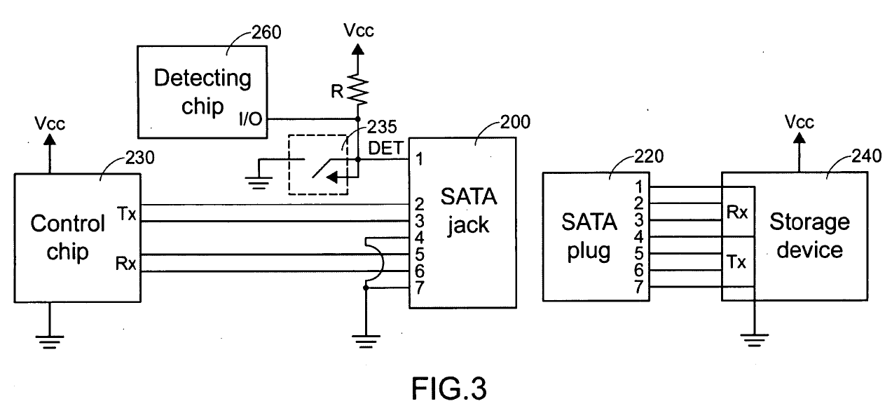

FIG. 3 is a schematic view illustrating the connection between an external device and a detecting device according to a second preferred embodiment of the present invention. As shown in FIG. 3, the detecting device of the present invention principally comprises a control chip 230, a pull-up element (e.g. a pull up resistor R), a SATA jack 200 and a detecting chip 260. The control chip 230, the pull up resistor R, the SATA jack 200 and the detecting chip 260 included in this embodiment are identical to those of FIG. 2, and are not redundantly described herein. In addition, an electronic switch 235 is arranged between the detecting pin DET and the ground layer. A control terminal of the electronic switch 235 is connected to the detecting pin DET. The electronic switch 235 is switched between an open state and a close state according to the level state at the detecting pin DET. In a case that the voltage level at the detecting pin DET is at a low-level state, the electronic switch 235 is in the close state such that the detecting pin DET is connected to the ground layer. Whereas, if the voltage level at the detecting pin DET is at a high-level state, the electronic switch 235 is switched to the open state such that the detecting pin DET is disconnected from the ground layer.

If the SATA plug 220 of the external device 240 is inserted into the SATA jack 200, the voltage level at the detecting pin DET of the SATA jack 200 is pulled down to a low-level state because the first electrical wire of the SATA plug 220 is connected to the ground voltage. Under this circumstance, the electronic switch 235 is switched to the close state such that the detecting pin DET is connected to the ground layer. Meanwhile, the current generated by the supply voltage (Vcc) will flow to the ground layer through the pull up resistor R and the electronic switch 235. Likewise, since the first electrical wire of the SATA plug 220 is connected to the ground voltage when the SATA plug 220 of the external device 240 is inserted into the SATA jack 200, the SATA plug 220 and the SATA jack 200 still conform to the definition of SATA interfaces.

From the above description, the detecting device of the present invention is capable of detecting the connecting status between a SATA jack and an external device without impairing the speeds of transmitting and receiving data. Moreover, the detecting device of the present invention can detect the presence of an external device as soon as the external device is inserted into the SATA jack. Since the detecting procedure is no longer implement during the BIOS is running, the method of detecting the presence of an external device is more time-saving and convenient.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A detecting device of a motherboard for detecting a connecting status of an external device, the detecting device comprising:
a control chip;
a pull-up element;
a jack comprising one or more first-type electrical wires, one or more second-type electrical wires and a third-type electrical wire, wherein the first-type electrical wires are connected to the control chip for receiving and transmitting data, the second-type electrical wires are connected to a first voltage, and the third-type electrical wire is connected to a second voltage through the pull-up element; and
a detecting chip having an I/O pin connected to the third-type electrical wire of the jack, wherein when the external device is not connected to the jack, the third-type electrical wire is maintained at the second voltage, and when the external device is connected to the jack, the third-type electrical wire is not maintained at the second voltage.

2. The detecting device according to claim 1 wherein the first voltage is a ground voltage and the second voltage is a supply voltage.

3. The detecting device according to claim 1 wherein the pull-up element is a pull-up resistor.

4. The detecting device according to claim 1 wherein the first-type electrical wires include transmitting wires and receiving wires.

5. The detecting device according to claim 1 wherein the control chip is a south bridge chip.

6. The detecting device according to claim 1 wherein the detecting chip is a super I/O device, a general purpose I/O device or a south bridge chip.

7. The detecting device according to claim 1 wherein the voltage level of the third-type electrical wire is changed from the second voltage to the first voltage when the external device is connected to the jack.

8. The detecting device according to claim 1 wherein the jack is a SATA jack.

9. The detecting device according to claim 1 wherein the external device is a hard disc or an optic disk drive.

10. A detecting device of a motherboard for detecting a connecting status of an external device, the detecting device comprising:
a control chip;
a pull-up element;
a jack comprising one or more first-type electrical wires, one or more second-type electrical wires and a third-type electrical wire, wherein the first-type electrical wires are connected to the control chip for receiving and transmitting data, the second-type electrical wires are connected to a first voltage, and the third-type electrical wire is connected to a second voltage through the pull-up element;
an electronic switch arranged between the third-type electrical wire and the first voltage; and
a detecting chip having an I/O pin connected to the third-type electrical wire of the jack, wherein when the external device is not connected to the jack, the third-type electrical wire is disconnected from the first voltage by the electronic switch such that the third-type electrical wire is maintained at the second voltage, and when the external device is connected to the jack, the third-type electrical wire is connected to the first voltage by the electronic switch such that the third-type electrical wire is maintained at the first voltage.

11. The detecting device according to claim 10 wherein the first voltage is a ground voltage and the second voltage is a supply voltage.

12. The detecting device according to claim 10 wherein the pull-up element is a pull-up resistor.

13. The detecting device according to claim 10 wherein the first-type electrical wires include transmitting wires and receiving wires.

14. The detecting device according to claim 10 wherein the control chip is a south bridge chip.

15. The detecting device according to claim 10 wherein the detecting chip is a super I/O device, a general purpose I/O device or a south bridge chip.

16. The detecting device according to claim 10 wherein the jack is a SATA jack.

17. The detecting device according to claim 10 wherein the external device is a hard disc or an optic disk drive.
